(19) United States
(12) Patent Application Publication
(10) Pub. No.: US 2011/0239614 A1
(43) Pub. Date: Oct. 6, 2011

(54) HAND MOWER

(76) Inventor: Hwei-Rung Chou, Taipei (TW)

(21) Appl. No.: 12/753,065

(22) Filed: Apr. 1, 2010

(51) Int. Cl. A01D 34/53

(52) U.S. Cl. 56/249

(57) ABSTRACT

A hand mower includes a base, a housing surrounding the base, a handle coupled to the housing, a cutting cylinder rotatably mounted on the front side of the base, two wheels mounted on the two distal ends of a center shaft of the cutting cylinder, two transmission gear sets, each comprising an internal gear fixedly located on one wheel, a driven gear fixedly mounted on the center shaft of the cutting cylinder and two intermediate gears meshed between the internal gear and the driven gear, and two one-way clutches respectively set between the center shaft of the cutting cylinder and the transmission gear sets for controlling transmission of force between the center shaft and the transmission gear sets.

### BACKGROUND OF THE INVENTION

(a) Field of the Invention

The present invention relates to lawn mowers and more particularly to a hand mower, which is to be pushed manually to rotate wheels and to simultaneously rotate a cutting cylinder to cut off grass.

(b) Description of the Prior Art

Regular lawn mowers include two types, the power driven type and the manual type. A power driven lawn mower uses an engine to rotate a cutter unit. When a user moves a power driven lawn mower after starting the engine, the cutter unit is rotated to cut off grass. However, when the power driven lawn mower is immovable, the engine and the cutter unit keep running. A manual type lawn mower or hand mower does not use an engine or any other power drive means. When a user pushes a hand mower on a lawn to rotate the wheels, a cutting cylinder is rotated with the wheels to cut off grass. When the hand mower is stopped, the cutting cylinder stands still.

According to conventional hand mower designs, multiple shafts are mounted inside the housing and linked to one another by external gears, and multiple external gears are arranged on the wheels and the shafts for transmission, enabling the cutter unit to be rotated with the wheels. These conventional designs have the common drawback of complicated transmission structure. When certain component parts are damaged, the repair work is complicated, and the related repair cost will be high. Further, the cutter blades of the cutter units of conventional hand mowers are not adjustable or replaceable, complicating the maintenance and repair work.

### SUMMARY OF THE INVENTION

The present invention has been accomplished under the circumstances in view. The hand mower according to the present invention comprises a base, a housing, a handle, a cutting cylinder, two wheels, two transmission gear sets and two one-way clutches, and has the characteristics of simple structure, compact size, low cost and ease of maintenance.

In another embodiment of the present invention, the hand mower further includes a connection structure between the housing and the handle such that a user can bias the handle relative to the housing freely, facilitating operation of the hand mower.

In yet another preferred embodiment of the present invention, the hand mower has the cutting cylinder designed for allowing the user to adjust the angles of the cutter blades and replace the cutter blades conveniently.

In yet another preferred embodiment of the present invention, the hand mower has the housing designed to provide a front access opening and trim panel detachably fastened to the front access opening to facilitate maintenance and cleaning.

### BRIEF DESCRIPTION OF THE DRAWINGS

FIG. 1 is an oblique elevation of a hand mower in accordance with the present invention.

FIG. 2 is an exploded view of the hand mower in accordance with the present invention.

FIG. 3 is a side view of the hand mower in accordance with the present invention.

FIG. 4 is a sectional elevation of the hand mower in accordance with the present invention.

FIG. 5 is a side view of an alternate form of the hand mower in accordance with the present invention.

FIG. 6 is an enlarged view of a part of FIG. 5, showing the connection structure between the handle and the housing.

FIG. 7 is a schematic drawing of a part of the present invention, showing the operation of the transmission gear set.

FIG. 8 is a schematic drawing of a part of the present invention, showing an operation status of the one-way clutches during forward rotation of the wheels.

FIG. 9 is a schematic drawing of a part of the present invention, showing an operation status of the one-way clutches during backward rotation of the wheels.

### DETAILED DESCRIPTION OF THE PREFERRED EMBODIMENTS

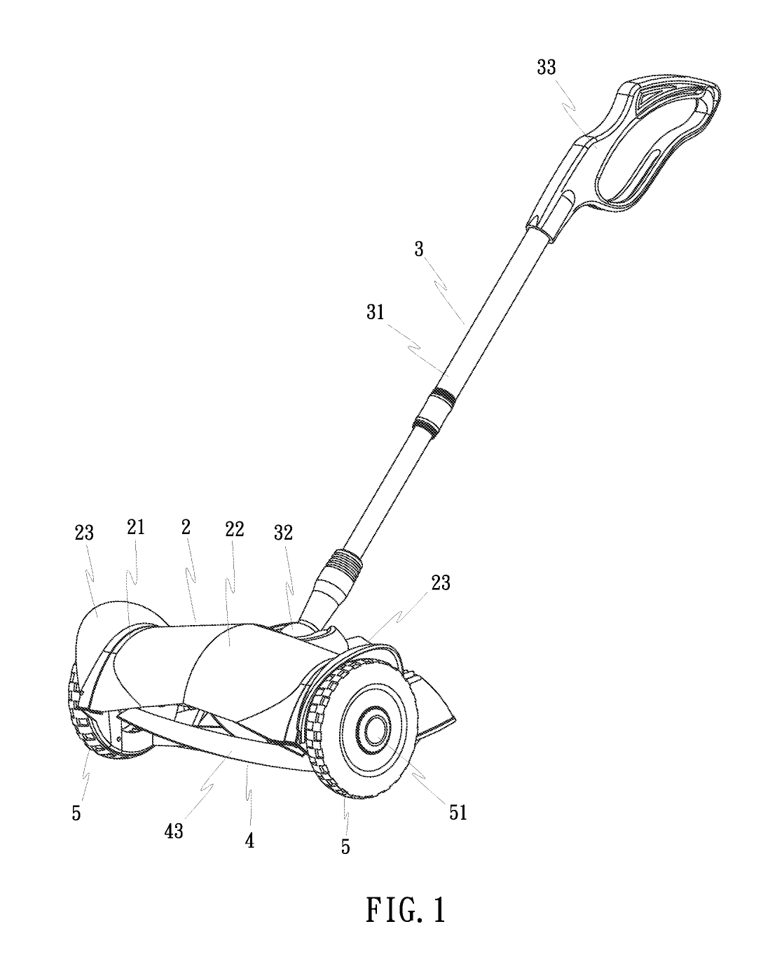

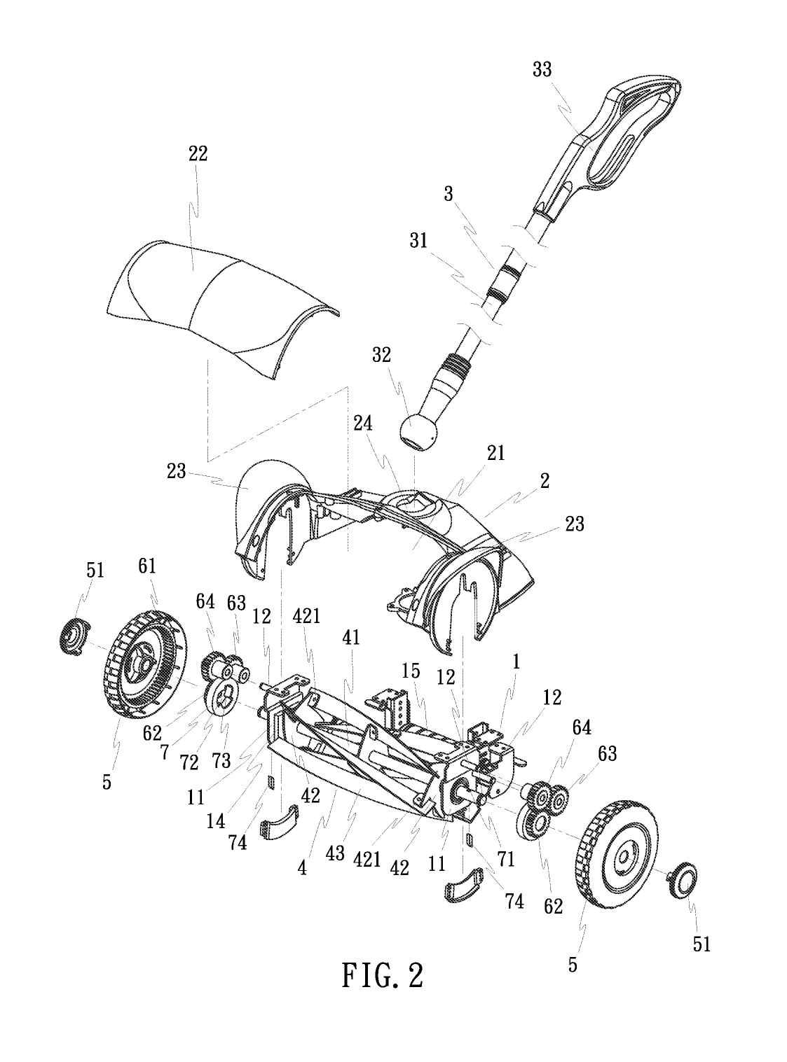

As shown in FIG. 1 and FIG. 2, a hand mower in accordance with the present invention comprises a base 1, a housing 2, a handle 3, a cutting cylinder 4, two wheels 5, at least one, for example, two transmission gear sets 6, and at least one, for example, two one-way clutches 7.

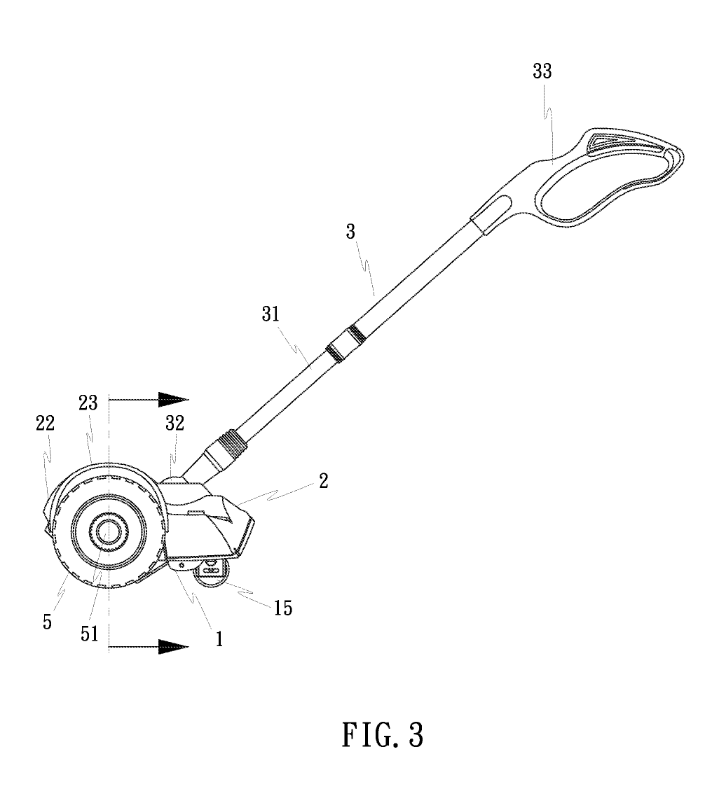

As shown in FIGS. 2-4, the base 1 comprises two bearing blocks 11 symmetrically disposed at two opposite lateral sides, two axles 12 and an axle bearing 13 located on each bearing block 11, a bearing cover 14 surrounding the axle bearing 13 at each bearing block 11, and a supplementary roller 15 pivotally mounted at the rear side thereof between the two bearing blocks 11.

As shown in FIG. 2, the housing 2 covers the base 1, having a front access opening 21, a trim panel 22 detachably fastened to the front access opening 21, two rounded wheel caps 23 protruding from the two opposite lateral sides thereof, and a ball socket hole 24 located on the middle near the rear side thereof for the connection of the handle 3.

As shown in FIG. 2, the handle 3 is fastened to the base 1. As illustrated, the handle 3 has an elongated shank 31 shaped like, for example, a round bar, a ball 32 located on the front end of the elongated shank 31 and rotatably coupled to the ball socket hole 24, and a grip 33 located on the rear end of the elongated shank 31 and configured to be held in a user's hand or hands.

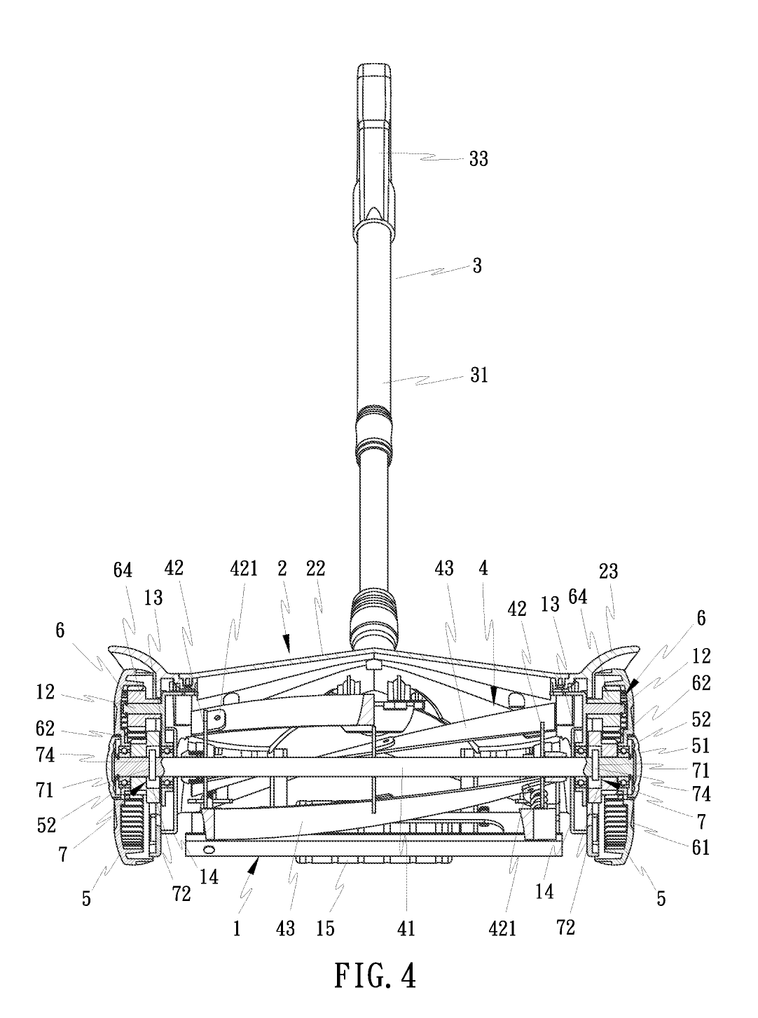

Referring to FIGS. 2 and 4 again, the cutting cylinder 4 is mounted at the front side of the base 1, comprising a shaft 41 that has its two distal ends respectively extending out of the two distal ends of the cutting cylinder 4 and respectively pivotally coupled to the bearing blocks 11 of the base 1. According to this embodiment, the two distal ends of the shaft 41 of the cutting cylinder 4 are respectively mounted in the axle bearing 13 at each of the two bearing blocks 11 so that the cutting cylinder 4 can be rotated smoothly relative to the base 1. The cutting cylinder 4 further comprises two cutter holders 42 affixed to the shaft 41 and respectively disposed adjacent to the bearing blocks 11 of the base 1, and a plurality of cutter blades 43 detachably and adjustably connected between the two cutter holders 42 around the shaft 41. According to this embodiment, the cutter holders 42 are multilateral plate members, each having a mounting lug 421 protruding from each of the multiple lateral edges thereof. The cutter blades 43 are spiral blades respectively connected between the mounting lugs 421 of the cutter holders 42.

Referring to FIGS. 2 and 4 again, the wheels 5 are respectively mounted on the two distal ends of the shaft 41 of the cutting cylinder 4 by a respective axle bearing 52 and secured thereto by a respective hubcap 51. Thus, the wheels 5 can be rotated relative to the cutting cylinder 4.

Referring to FIG. 4 again, each transmission gear set 6 comprises an internal gear 61 formed integral with or fixedly mounted in the inside wall of one wheel 5, a driven gear 62 fixedly mounted on the shaft 41 of the cutting cylinder 4, and two intermediate gears 63 and 64 respectively mounted on the axles 12 at the associated bearing block 11 of the base 1 meshed between the internal gear 61 and the driven gear 62.

Referring to FIG. 8 and FIGS. 2 and 4 again, the two one-way clutches 7 are respectively provided between the shaft 41 of the cutting cylinder 4 and the driven gears 62 of the two transmission gear sets 6. Each one-way clutch 7 comprises a pin hole 71 transversely cut through the shaft 41 of the cutting cylinder 4 near its one end, a recessed hole 72 located on the inner side (or outer side) of the driven gear 62 of one transmission gear set 6 and defining therein a plurality of push faces 73, and a lever rod 74 movably inserted in the pin hole 71 and stoppable with one end thereof against one push face 73 in the recessed hole 72. Further, an arched face 75 is located in the recessed hole 72 between two push faces 73. Further, the lever rod 74 has an arched end face 741 located on each of the two distal ends thereof. Thus, the push face 73 can simply push the lever rod 74 forwards to rotate the cutting cylinder 4 clockwise. On the contrary, when the push face 73 is rotated in the reversed direction, it cannot push the lever rod 74.

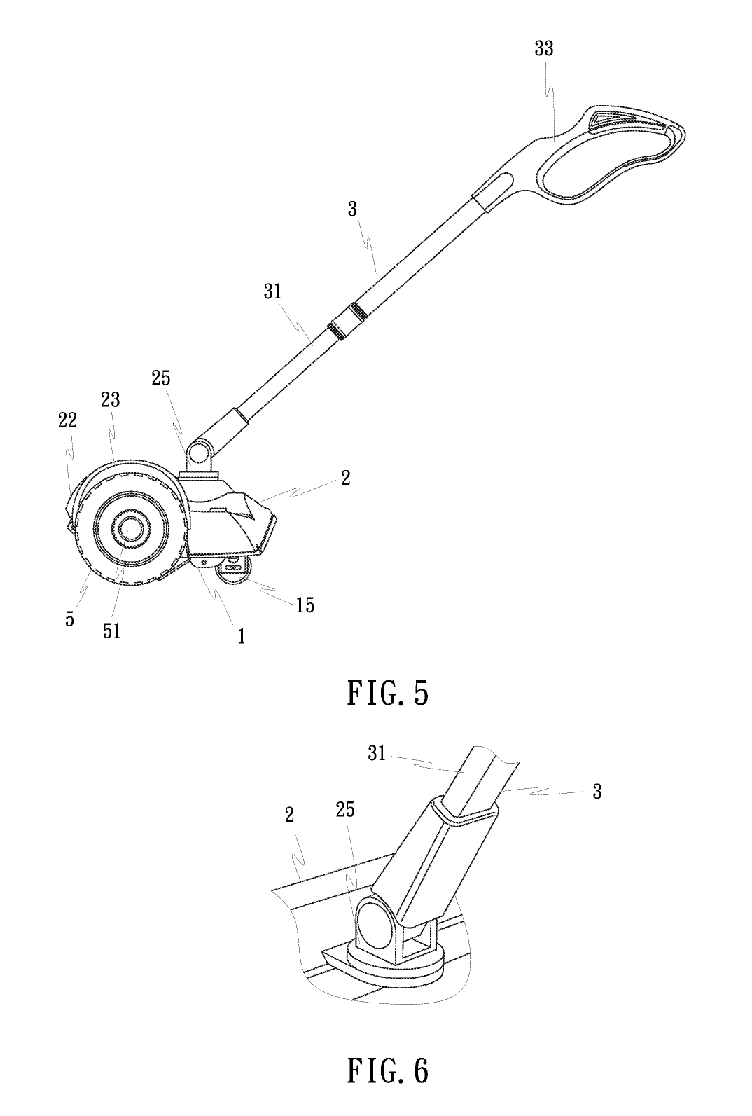

FIGS. 5 and 6 show an alternate form of the present invention. According to this alternate form, a pivot holder 25 is located on the top side of the housing 2; the handle 3 has an elongated shank 31, which is shaped like, for example, a round bar, and has its one end, namely, the front end pivotally connected to the pivot holder 25 at the housing 2 and its other end, namely, the rear end terminating in a grip 33 that is configured to be held in a user's hand or hands.

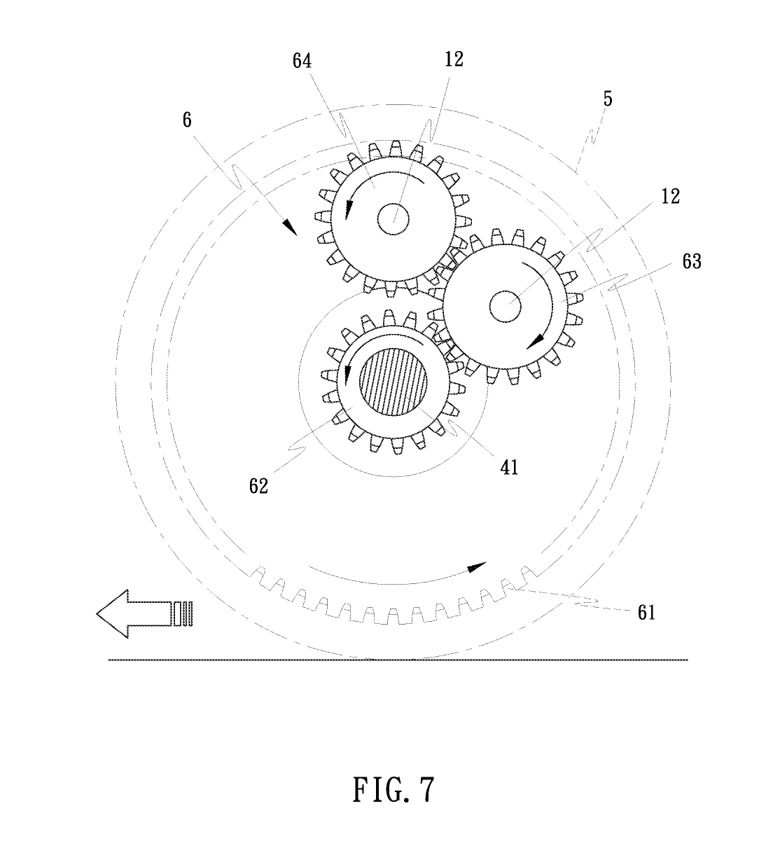

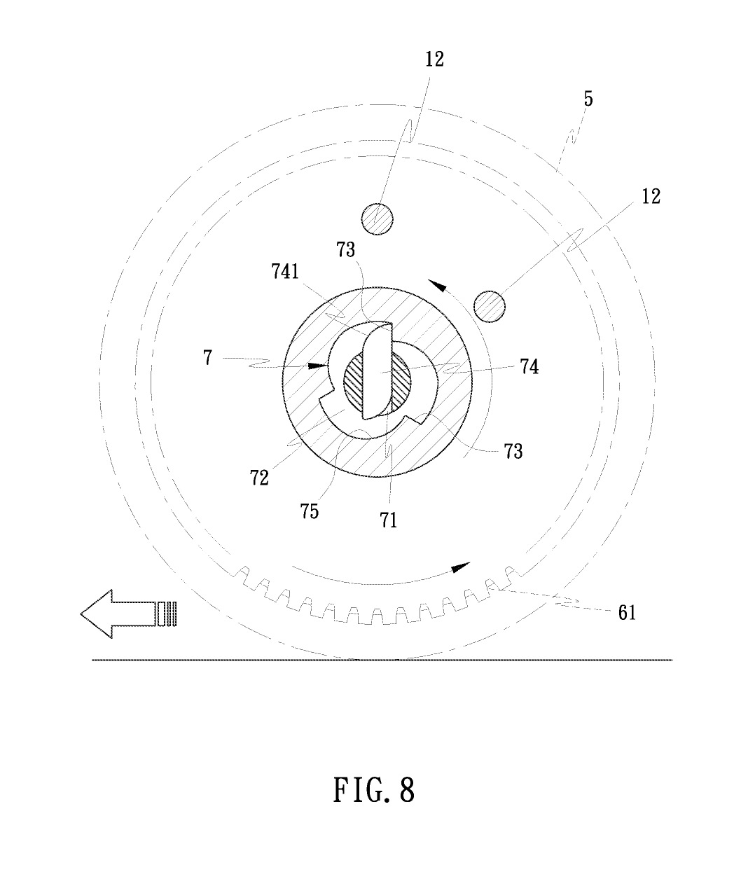

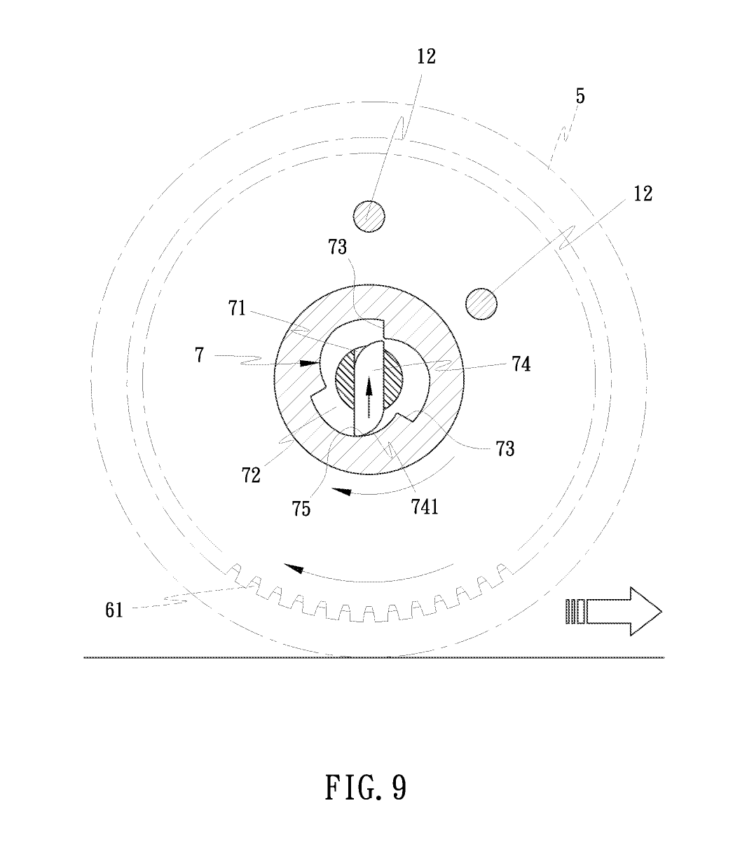

When using the hand mower to mow a lawn, the hand mower is put on the lawn, and then the grip 33 of the handle 3 is held in the user's hand or hands and pushed by the user to move the hand mower forwards on the lawn. As shown in FIG. 7, when the user is pushing the hand mover, a friction force is produced between the wheels 5 and the lawn, thereby causing the wheels 5 to be rotated forwards on the law. At the same time, the internal gears 61 of the transmission gear sets 6 are moved with the wheels 5 to rotate the intermediate gears 63 and 64 and the associated driven gears 62. As shown in FIG. 8, during rotation of the driven gears 62, the push faces 73 of the respective one-way clutches 7 are forced to move the associated lever rods 74 and the shaft 41, causing synchronous rotation of the cutting cylinder 4 to cut down grass. Further, as shown in FIG. 9, when the user pulls the hand mower backwards, the wheels 5 are rotated in the reverse direction, and at the same time the internal gears 61 are moved with the wheels 5 to reverse the intermediate gears 63 and 64 and the associated driven gears 62. At this time, the arched faces 75 in the recessed holes 72 of the one-way clutches 7 cannot push the arched end faces 741 of the associated lever rods 74, and therefore the cutting cylinder 4 is not rotated during backward rotation of the wheels 5.

Thus, when the user repeatedly pushes and pulls the hand mower in a specific block in the lawn, the specific block of the lawn can be accurately mowed.

As stated above, the transmission gear sets 6 are designed such that an internal gear 61 is moved to rotate two intermediate gears 63 and 64 and a driven gear 62. This arrangement eliminates the arrangement of multiple shafts, thus simplifying the structure and enabling the transmission gear sets 6 to be moved with the wheels 5 to rotate the center shaft 41 of the cutting cylinder 4 accurately. Thus, the hand mower has the characteristics of simple structure, compact size, low cost and ease of maintenance. Further, the ball and socket arrangement between the ball 32 of the handle 3 and the ball socket hole 24 of the housing 2 allows the user to bias the handle 3 freely relative to the housing 2 and the base 1 in different directions. The pivot connection between the elongated shank 31 of the handle 3 and the pivot holder 25 at the housing 2 allows the user to bias the handle 3 relative to the housing 2 and the base 1 in changing the moving direction of the hand mower when the hand mower is being moved to an uneven lawn area or corner area. Further, the cutter blades 43 of the cutting cylinder 4 are detachably and adjustably connected between the two cutter holders 42 around the shaft 41. Thus, the user can adjust the angles of the cutter blades 43. When the cutter blades 43 start to wear or are damaged, they can be replaced with new ones. Further, the trim panel 22 is detachably fastened to the front access opening 21 of the housing 2. When a repair or cleaning work is necessary, the user can detach the trim panel 22 to access the inside of the base 1 through the front access opening 21.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A hand mower, comprising:
a base;
a housing surrounding said base;
a handle connected to one of said base and said housing;
a cutting cylinder mounted at a front side of said base and rotatable relative to said base, said cutting cylinder comprising a center shaft, said center shaft having two distal ends thereof respectively extending out of two opposite lateral sides of said cutting cylinder and coupled to said housing;
two wheels respectively mounted on the two distal ends of said center shaft of said cutting cylinder and rotatable relative to said center shaft;
at least one transmission gear set, each said transmission gear set comprising an internal gear fixedly located on one said wheel, a driven gear fixedly mounted on said center shaft of said cutting cylinder, and two intermediate gears meshed between said internal gear and said driven gear; and
at least one one-way clutch respectively mounted between said center shaft of said cutting cylinder and the driven gear of each said transmission gear set.

2. The hand mower as claimed in claim 1, wherein each said one-way clutch comprises a pin hole transversely cut through said center shaft of said cutting cylinder, a recessed hole located on the driven gear of one said transmission gear set and defining therein a plurality of push faces, and a lever rod movably inserted in said pin hole and stoppable with one end thereof against one push face in said recessed hole.

3. The hand mower as claimed in claim 2, wherein each said one-way clutch further comprises an arched face located in the recessed hole thereof between two push faces in the recessed hole; said lever rod has an arched end face located on each of the two distal ends thereof.

4. The hand mower as claimed in claim 1, wherein said base comprises two bearing blocks respectively located on two opposite lateral sides thereof, and two axles and an axle bearing located on each said bearing block; said cutting cylinder is mounted between said two bearing blocks of said base; said center shaft of said cutting cylinder has the two distal ends thereof respectively pivotally coupled to the axle bearing at each of said two bearing blocks of said base; the intermediate gears of each said transmission gear set are mounted on the axles at each said bearing block of said base.

5. The hand mower as claimed in claim 1, wherein said cutting cylinder further comprises two cutter holders affixed to said center shaft, and a plurality of cutter blades detachably and adjustably connected between said two cutter holders around said center shaft.

6. The hand mower as claimed in claim 1, wherein said housing comprises a ball socket hole; said handle comprises an elongated shank and a ball fixedly located on one end of said elongated shank and rotatably coupled to said ball socket hole.

7. The hand mower as claimed in claim 6, wherein said handle further comprises a grip located on an opposite end of said elongated shank remote from said ball.

8. The hand mower as claimed in claim 1, wherein said housing comprises a pivot holder located at a top side thereof; said handle comprises an elongated shank, said elongated shank having a front end thereof pivotally connected to said pivot holder.

9. The hand mower as claimed in claim 8, wherein said handle further comprises a grip located on a rear end of said elongated shank remote from said pivot holder.

10. The had mower as claimed in claim 1, wherein said housing comprises an access opening located on a front side thereof, a trim panel detachably fastened to said access opening, and two wheel caps protruding from two opposite lateral sides thereof and configured to guard said wheels.
